(19) United States
(12) Patent Application Publication
(10) Pub. No.: US 2021/0097239 A1
(43) Pub. Date: Apr. 1, 2021

(54) SYSTEM AND METHOD FOR SOLVING TEXT SENSITIVITY BASED BIAS IN LANGUAGE MODEL

(71) Applicant: Samsung Electronics Co., Ltd., Gyeonggi-do (KR)

(72) Inventors: Himanshu ARORA, Bangalore (IN); Sugam GARG, Bangalore (IN); Barath Raj KANDUR RAJA, Bangalore (IN); Likhith AMARVAJ, Bangalore (IN); Sumit KUMAR, Bangalore (IN); Sriram SHASHANK, Bangalore (IN); Sanjana TRIPURAMALLU, Bangalore (IN); Chinmay ANAND, Bangalore (IN)

(73) Assignee: Samsung Electronics Co., Ltd.

(21) Appl. No.: 17/034,987

(22) Filed: Sep. 28, 2020

(30) Foreign Application Priority Data
Sep. 27, 2019 (IN) 201941039267 (PS)
Sep. 10, 2020 (IN) 201941039267 (CS)

(51) Int. Cl. G06F 40/35; G06F 40/253; G06F 40/274; G06F 16/9536; G06N 20/00

(52) U.S. Cl. CPC G06F 40/35; G06F 40/253; G06N 20/00; G06F 16/9536; G06F 40/274

(57) ABSTRACT

A method for determining sensitivity-based bias of text includes detecting an input action performed by a user from a plurality of actions, wherein the plurality of actions comprises typing one or more words on a virtual keyboard of a user device and accessing readable content on the user device. When the input action is accessing the readable content on the user device, determining the readable content to be insensitive by parsing the readable content and feeding the parsed readable content to a machine learning (ML) model, wherein the ML model is trained with insensitive datasets of an adversarial database, and presenting a first alert message on the user device before displaying the readable content completely on the user device when the readable content is determined to be insensitive. When the input action is typing the one or more words on the virtual keyboard of the user device, determining the one or more words to be insensitive by parsing the one or more words and feeding the parsed one or more words to the ML model, predicting that a next word to be suggested is insensitive when the one or more words are determined to be insensitive, and performing at least one of presenting a second alert message on the user device when the one or more words are determined to be insensitive, and presenting one or more alternate words for the next word as a suggestion for typing on the user device when the next word is predicted to be insensitive.

### CROSS-REFERENCE TO RELATED APPLICATION(S)

This application is based on and claims priority under 35 U.S.C. § 119 to Indian Provisional Patent Application No. 201941039267 (PS), filed on Sep. 27, 2019, in the Indian Patent Office, and Indian Complete Patent Application No. 201941039267 (CS), filed on Sep. 10, 2020, in the Indian Patent Office, the entire disclosures of each of which are incorporated herein by reference.

### BACKGROUND

### 1. Field

The present disclosure relates generally to computational linguistics, and particularly, to a system and a method for identifying text sensitivity-based bias in a language model.

### 2. Description of Related Art

With the increasing popularity of social media, regulating content posted in social media or regulating contents exchanged through cross-platform messaging services has become a challenge. For instance, a user may exchange content in the form of text, emoticons, or images with another person. In doing so, the user may not realize that the sent content may be insensitive to another person. Further, the insensitivity of content varies from person to person and is a highly subjective matter. For example, content insensitive to one person may not be insensitive to another person. Hence, it is important to identify and inform content or text that may be insensitive to a user.

Accordingly, there is a need for an approach to solve or regulate text sensitivity-based bias in content.

### SUMMARY

The disclosure has been made to address the above-mentioned problems and disadvantages, and to provide at least the advantages described below

According to an aspect of the disclosure, a method for determining sensitivity-based bias of text includes detecting an input action performed by a user from a plurality of actions, wherein the plurality of actions comprises typing one or more words on a virtual keyboard of a user device and accessing readable content on the user device. When the input action is accessing the readable content on the user device, determining the readable content to be insensitive by parsing the readable content and feeding the parsed readable content to a machine learning (ML) model, wherein the ML model is trained with insensitive datasets of an adversarial database, and presenting a first alert message on the user device before displaying the readable content completely on the user device when the readable content is determined to be insensitive. When the input action is typing the one or more words on the virtual keyboard of the user device, determining the one or more words to be insensitive by parsing the one or more words and feeding the parsed one or more words to the ML model, predicting that a next word to be suggested is insensitive when the one or more words are determined to be insensitive, and performing at least one of presenting a second alert message on the user device when the one or more words are determined to be insensitive, and presenting one or more alternate words for the next word as a suggestion for typing on the user device when the next word is predicted to be insensitive.

According to another aspect of the disclosure, a server device for determining sensitivity-based bias of text includes a processor, and a memory communicatively coupled to the processor, wherein the memory stores processor-executable instructions, which upon execution, cause the processor to receive an input action performed by a user from a plurality of actions, wherein the plurality of actions comprises typing one or more words on a virtual keyboard of a user device and accessing readable content on the user device. When the input action is accessing the readable content on the user device, determine the readable content to be insensitive by parsing the readable content and feeding the parsed readable content to an ML model, wherein the ML model is trained with insensitive datasets of an adversarial database, and send a first alert message to the user device before displaying the readable content completely on the user device when the readable content is determined to be insensitive. When the input action is typing the one or more words on the virtual keyboard of the user device, determine the one or more words to be insensitive by parsing the one or more words and feeding the parsed one or more words to the ML model, predict that a next word to be suggested is insensitive when the one or more words are determined to be insensitive, and perform at least one of sending a second alert message to the user device when the one or more words are determined to be insensitive, and sending one or more alternate words for the next word as a suggestion for typing on the user device when the next word is predicted to be insensitive.

According to another aspect of the disclosure, a user device includes a display, a processor, and a memory communicatively coupled to the processor, wherein the memory stores processor-executable instructions, which upon execution, cause the processor to detect, on the display, an input action performed by a user from a plurality of actions, wherein the plurality of actions comprises typing one or more words on a virtual keyboard of a user device and accessing readable content on the display. When the input action is accessing the readable content on the display, determine the readable content to be insensitive by parsing the readable content and feeding the parsed content to an ML model, wherein the ML model is trained with insensitive datasets of an adversarial database, and present a first alert message on the display before displaying the readable content completely on the display when the readable content is determined to be insensitive. When the input action is typing the one or more words on the virtual keyboard of the user device, determine the one or more words to be insensitive by parsing the one or more words and feeding the parsed one or more words to the ML model, predict that a next word to be suggested is insensitive when the one or more words are determined to be insensitive. and perform at least one of presenting a second alert message on the display when the one or more words are determined to be insensitive, and presenting one or more alternate words for the next word as a suggestion for typing on the display when the next word is predicted to be insensitive.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates displaying a warning message when text with sensitivity-based bias is found on a user device, according to an embodiment;

FIG. 1B illustrates displaying a warning message when text with sensitivity-based bias is found on a user device, according to an embodiment;

FIG. 2A illustrates an example of solving text sensitivity-based bias when typing one or more words on a virtual keyboard of a user device, according to an embodiment;

FIG. 2B illustrates an example of solving text sensitivity-based bias when typing one or more words on a virtual keyboard of a user device, according to an embodiment;

FIG. 2C illustrates an example of solving text sensitivity-based bias when typing one or more words on a virtual keyboard of a user device, according to an embodiment;

FIG. 2D illustrates an example of solving text sensitivity-based bias when typing one or more words on a virtual keyboard of a user device, according to an embodiment;

FIG. 2E illustrates an example of solving text sensitivity-based bias when typing one or more words on a virtual keyboard of a user device, according to an embodiment;

FIG. 2F illustrates an example of solving text sensitivity-based bias when typing one or more words on a virtual keyboard of a user device, according to an embodiment;

FIG. 2G illustrates an example of solving text sensitivity-based bias when typing one or more words on a virtual keyboard of a user device, according to an embodiment;

FIG. 3 shows a detailed block diagram of a text sensitivity assisting system, according to an embodiment;

FIG. 4A illustrates an overall system for categorizing sensitivity based on bias, according to an embodiment;

FIG. 4B illustrates process of categorizing sensitivity based on bias, according to an embodiment;

FIG. 4C illustrates how a sensitivity classifier is trained, according to an embodiment;

FIG. 4D illustrates how a sensitivity aware language model is trained, according to an embodiment;

FIG. 5A illustrates a flowchart showing a method for determining sensitivity-based bias of text, according to an embodiment;

FIG. 5B illustrates a detailed flowchart showing a method for determining sensitivity-based bias of text, according to an embodiment; and

FIG. 6 illustrates a flowchart showing a method for populating an adversarial database, according to an embodiment.

### DETAILED DESCRIPTION

Various embodiments of the disclosure are described with reference to the accompanying drawings. However, various embodiments of the disclosure are not limited to particular embodiments, and it should be understood that modifications, equivalents, and/or alternatives of the embodiments described herein can be variously made. With regard to description of drawings, similar components may be marked by similar reference numerals.

In addition, it will be appreciated that any flowcharts, flow diagrams, state transition diagrams, and pseudo code represent various processes which may be substantially represented in a computer readable medium and executed by a computer or processor. In the disclosure, the word “exemplary” is used to mean “serving as an example”, “serving as an instance”, or “serving as an illustration”. Any embodiment or implementation of the present subject matter described as “exemplary” is not necessarily to be construed as preferred or advantageous over other embodiments.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such a setup, device or method. In other words, one or more elements in a system or apparatus proceeded by “comprises” does not preclude the existence of various additional elements in the system or method.

In the following detailed description of the embodiments of the disclosure, reference is made to the accompanying drawings that form a part thereof. These embodiments are described in sufficient detail to enable those skilled in the art to practice the disclosure, and it is to be understood that other embodiments may be utilized and changes may be made without departing from the scope of the present disclosure.

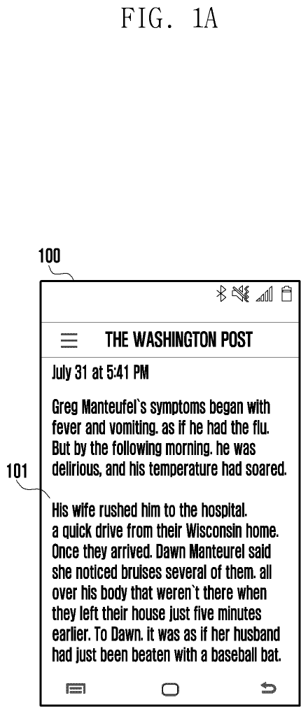

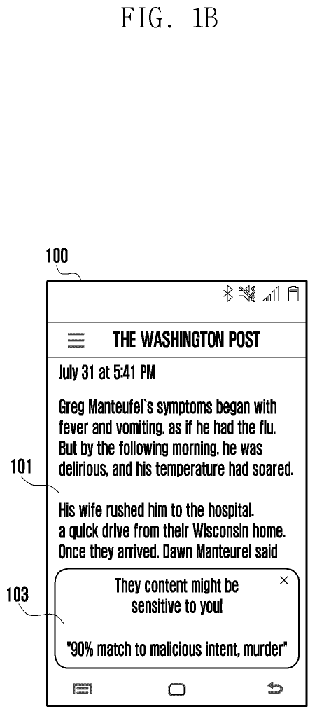

FIGS. 1A-1B illustrate displaying a warning message when text with sensitivity-based bias is found on a user device, in accordance with various embodiments.

Referring to FIG. 1A, an environment includes a user device 100 and readable content 101 on the user device 100 display. The user device 100 may include, but is not limited to, a mobile terminal, a tablet computer, a desktop and a laptop. A person skilled in the art would understand that, any electronic device with a display, not mentioned explicitly, may also be used as the user device 100. The user device 100 comprises a text sensitivity assisting system as a built-in feature or as an on-device feature.

When a user is accessing readable content 101 on the user device 100, the text sensitivity assisting system may extract sentences from the readable content 101. Subsequently, the text sensitivity assisting system may determine if the readable content 101 is insensitive to the user by parsing the extracted sentences and feeding the parsed sentences to an ML model, which is a part of the text sensitivity assisting system. The ML model may be trained with insensitive datasets belonging to an adversarial database. The adversarial database may refer to a database comprising datasets with words and/or phrases that are insensitive, inappropriate, or vulgar to any user.

The datasets may be categorized based on one of, but not limited to, country bias, political bias, entity bias, hate speech and gender bias. When the text sensitivity assisting system determines the readable content 101 to be insensitive, the text sensitivity assisting system may present an alert message 103 on the user device 100, shown in the FIG. 1B. This alert message 103 may be referred as a first alert message. The first alert message 103 may contain information on bias. The first alert message 103 may contain information indicating category of bias. For instance, in the FIG. 1B, the first alert message 103 shows information on bias as “90% match to malicious intent, murder”. When the readable content 101 is determined to be insensitive, the text sensitivity assisting system may display the readable content 101 completely on the user device 100 only after receiving consent from the user. The first alert message 103 may be displayed to the user device 100 such that the text content which is determined to be biased is masked.

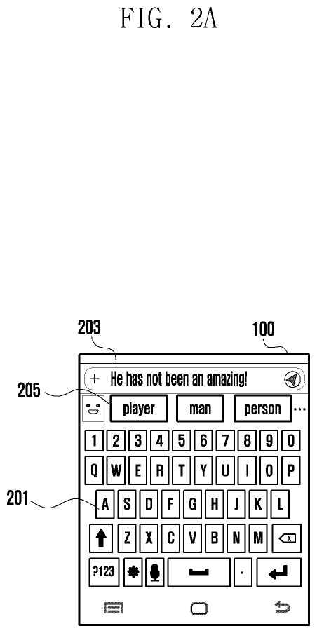

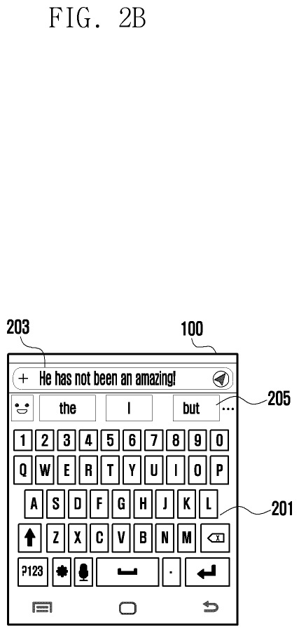

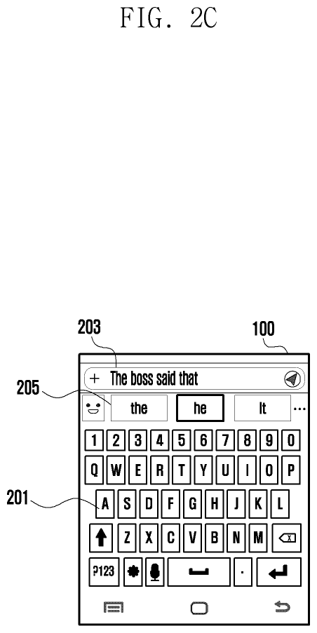

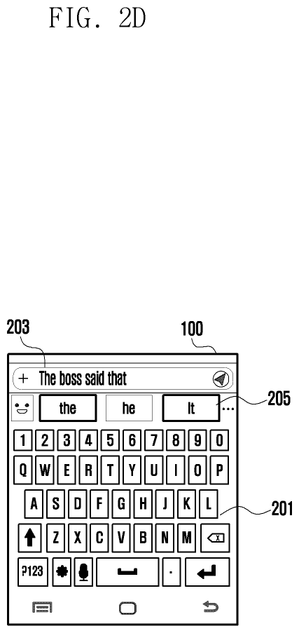

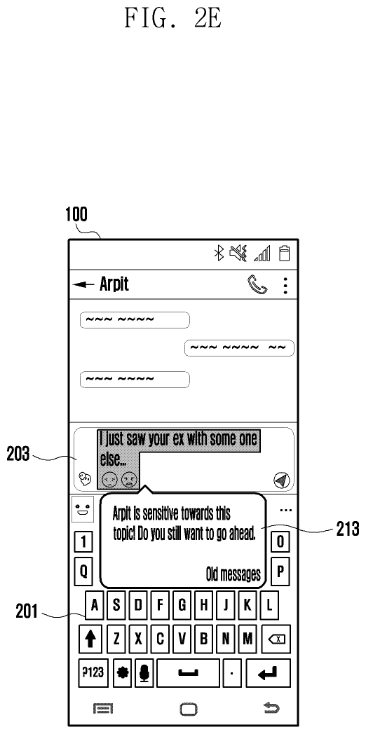

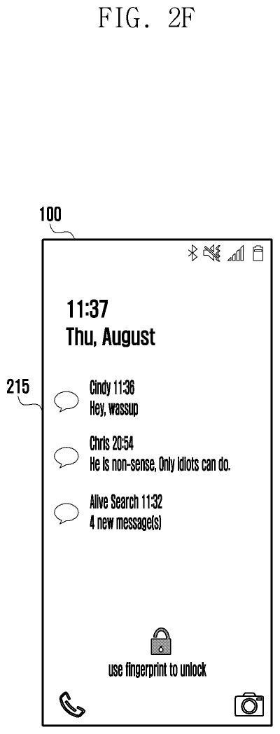

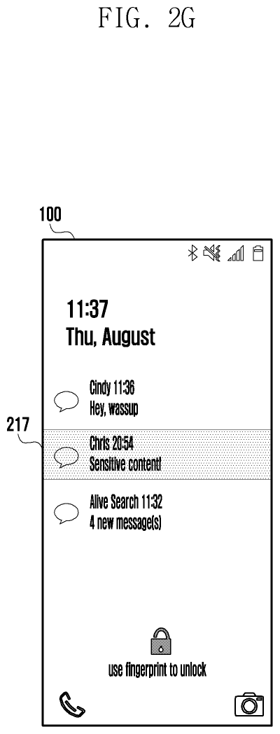

FIGS. 2A-2G illustrate examples of solving text sensitivity-based bias when typing one or more words on a virtual keyboard of a user device, according to various embodiments.

Referring to FIGS. 2A-2D, an environment of the user device 100 comprises a virtual keyboard 201 on the user device 100, a typed message area 203 on the user device 100 and a words suggestion area 205 on the user device 100. The typed message area 203 may be referred as an area for writing or typing a message.

Referring to FIG. 2A, when a user is typing the one or more words on the virtual keyboard 201 of the user device 100, the text sensitivity assisting system may determine if the typed one or more words in the typed message area 203 is insensitive by parsing the typed one or more words and feeding the parsed one or more words to the ML model, which is a part of the text sensitivity assisting system. The ML model may be trained with insensitive datasets belonging to an adversarial database. The adversarial database may refer to a database comprising datasets with words and/or phrases that are insensitive, inappropriate, or vulgar to any user. The datasets may be categorized based on one of, but not limited to, country bias, political bias, entity bias, hate speech and gender bias. When the text sensitivity assisting system determines the typed one or more words in the typed message area 203 to be insensitive, the text sensitivity assisting system may present one or more alternate words for the next word as a suggestion on the words suggestion area 205 for typing on the typed message area 203 on the user device 100. The one or more alternate words that are suggested for the next word may specifically not be insensitive words. “Not insensitive words” may refer to words that are appropriate, or not vulgar to any user.

Referring to FIG. 2A, when a user types one or more words (i.e., “He has not been an amazing”), one or more alternate words such may be suggested, such as “player”, “man”, and “person”.

Referring to FIG. 2B, when the user types one or more words (i.e., “He has not been an amazing”), the typed one or more words in the typed message area 203 may be determined to be insensitive. In this case, the text sensitivity assisting system may consider the typed one or more words to be under a category of hate speech bias. Subsequently, the text sensitivity assisting system may present one or more alternate words, such as, “the”, “i”, and “but”, for the next word as a suggestion on the words suggestion area 205 on the user device 100.

With reference to FIG. 2C, when a user types one or more words (i.e., “The boss said that”), the current state of the art suggests one or more alternate words such as “the”, “he”, “it”, etc. With reference to the FIG. 2D, when the user types one or more words i.e. “The boss said that”, the present disclosure determines the typed one or more words in the typed message area 203 to be insensitive. In this case, the text sensitivity assisting system may consider the typed one or more words to be under a category of gender bias. Subsequently, the text sensitivity assisting system may present one or more alternate words such as “he”, “the”, “she”, etc., for the next word as a suggestion on the words suggestion area 205 on the user device 100.

When a user is typing the one or more words on the virtual keyboard 201 of the user device 100, the text sensitivity assisting system may determine if a suggested next word for typing is insensitive. If the suggested next word is determined to be insensitive, the text sensitivity assisting system may present one or more alternate words for the suggested next word on the words suggestion area 205 for typing on the typed message area 203 on the user device 100. The one or more alternate words for the suggested next word may not be insensitive words.

When a user is typing the one or more words on the virtual keyboard 201 of the user device 100, the text sensitivity assisting system may determine if the typed one or more words in the typed message area 203 and a suggested next word for typing are insensitive. If the typed one or more words in the typed message area 203 and the suggested next word for typing are determined to be insensitive, the text sensitivity assisting system may present one or more alternate words for the suggested next word on the words suggestion area 205 for typing on the typed message area 203 on the user device 100. The one or more alternate words for the suggested next word may not be insensitive words.

Referring to FIG. 2E, an environment of the user device 100 comprises the virtual keyboard 201 on the user device 100 and the typed message area 203 on the user device 100. The typed message area 203 may be referred as an area for writing or typing a message.

When a user is typing the one or more words, on the virtual keyboard 201 of the user device 100, the text sensitivity assisting system may determine if the typed one or more words in the typed message area 203 are insensitive by parsing the typed one or more words and feeding the parsed one or more words to the ML model, which is a part of the text sensitivity assisting system. The ML model may be trained with insensitive datasets belonging to an adversarial database. Here, the adversarial database may refer to a database comprising datasets with words and/or phrases that are insensitive, inappropriate, or vulgar to any user. The datasets may be categorized based on one of, but not limited to, country bias, political bias, entity bias, hate speech and gender bias. When the text sensitivity assisting system determines the typed one or more words in the typed message area 203 to be insensitive, the text sensitivity assisting system may present an alert message 213 on the user device 100, shown in the FIG. 2E. This alert message 213 may be referred as a second alert message. The second alert message 213 may contain information on bias and/or information indicating a category of bias. For instance, in FIG. 2E, the second alert message 103 shows information on bias as “Arpit is sensitive towards this topic! Do you still want to go ahead.” Thus, it would be insensitive to post those words here. When the typed one or more words are determined to be insensitive, the text sensitivity assisting system may allow the user to access the virtual keyboard 201 on the user device 100 only after receiving consent from the user.

The text sensitivity assisting system may determine text sensitivity-based bias when a sentence or sentences are typed by a user in the typed message area 203 on the user device 100, as shown in the FIG. 2E.

The text sensitivity assisting system may determine text sensitivity-based bias when an emotion icon (also referred as emoticon), an image or a text embedded picture or image is typed by a user in the typed message area 203 on the user device 100.

Referring to FIGS. 2F-2G, the user device 100 is an environment where the user device 100 has a display or a screen in a lock state. The lock state of a screen or a display may refer to a situation in which a user may receive notifications or message alerts. In order to read complete notifications or message alerts, the user may have to unlock the display or the screen of the user device 100.

Referring to FIG. 2F, a user receives a message 215 including the text, “He is non-sense. Only idiots can do.”

Referring to the FIG. 2G, when a user receives the message 215, the text sensitivity assisting system of the present disclosure may determine if the received message is insensitive by parsing the received message and feeding the parsed message to the ML model, which is a part of the text sensitivity assisting system. The ML model may be trained with insensitive datasets belonging to an adversarial database. The adversarial database may refer to a database comprising datasets with words and/or phrases that are insensitive, inappropriate, or vulgar to any user. The datasets may be categorized based on one of, but not limited to, country bias, political bias, entity bias, hate speech and gender bias. When the text sensitivity assisting system determines the received message to be insensitive, the text sensitivity assisting system may present an alert message 217 on the user device 100, shown in the FIG. 2G. This alert message 217 may hide the actual received message when the received message is determined to be insensitive and present information as “Sensitive content!”. The alert message 217 may contain information on bias and/or information indicating a category of bias. Here, the received message may be text content comprising at least one of one or more words and one or more sentences. The received message may be related to various applications installed in the user device 100.

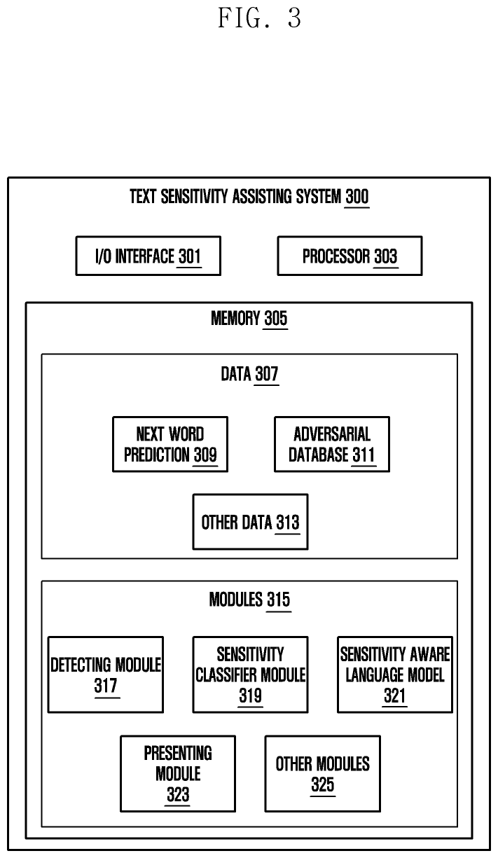

FIG. 3 shows a detailed block diagram of a text sensitivity assisting system, according to an embodiment.

The text sensitivity assisting system 300 includes an input/output (I/O) interface 301, a processor 303, a section of memory 305 for storing data 307 and a section of the memory 305 for storing one or more modules 315.

The text sensitivity assisting system 300 may receive input via the I/O interface 301. The input may be a readable content when a user is accessing the readable content on the user device 100 or the input may be one or more words when the user is typing the one or more words on the virtual keyboard 201 of the user device 100. Since the text sensitivity assisting system 300 may be present in the user device 100 as a built-in feature or as an on-device feature, the I/O interface 301 may be configured to communicate with the user device 100 using any internal communication protocols or methods. The sensitivity assisting system 300 may be present in the server device, the I/O interface 301 may be configured to communicate with the user device 100 using various external communication protocols or methods of communication.

The input received by the I/O interface 301 may be stored in the memory 305. The memory 305 may be communicatively coupled to the processor 303 of the text sensitivity assisting system 300. The memory 305 may, also, store processor instructions which may cause the processor 303 to execute the instructions for determining sensitivity-based bias of text. The memory 305 may include memory drives and removable disc drives. The memory drives may further include a drum, a magnetic disc drive, a magneto-optical drive, an optical drive, a redundant array of independent discs (RAID), solid-state memory devices, and solid-state drives.

The processor 303 may include at least one data processor for determining sensitivity-based bias of text. The processor 303 may include specialized processing units such as integrated system (i.e., bus) controllers, memory management control units, floating point units, graphics processing units, and digital signal processing units.

The data 307 may be stored within the memory 305. The data 200 may include next word prediction data 309, an adversarial database 311 and other data 313.

The next word prediction data 309 may include one or more alternate words. These one or more alternate words may be for suggesting a next word for typing on the user device when the next word is predicted to be insensitive.

The adversarial database 311 may contain datasets that are insensitive in nature. These insensitive datasets may be categorized based on one of, but not limited to, country bias, political bias, entity bias, hate speech and gender bias and saved in the adversarial database 311. The adversarial database 311 may be updated at pre-defined intervals of time. The adversarial database 311 may be updated continuously whenever there is a new dataset to be added to the adversarial database 311. The updates may be performed by an ML model trained with the insensitive datasets of the adversarial database 311 for adaptive learning.

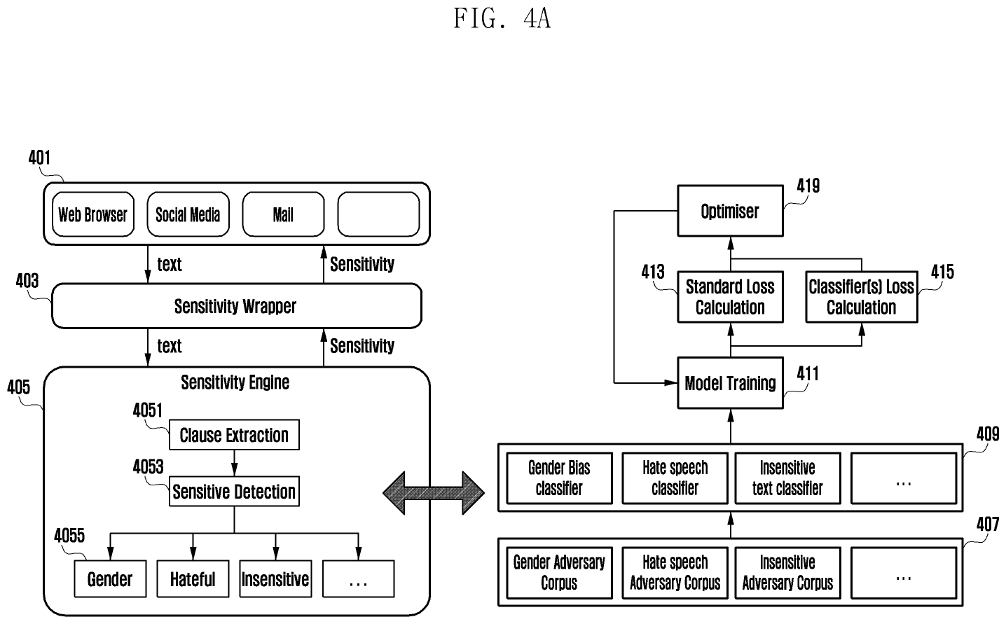

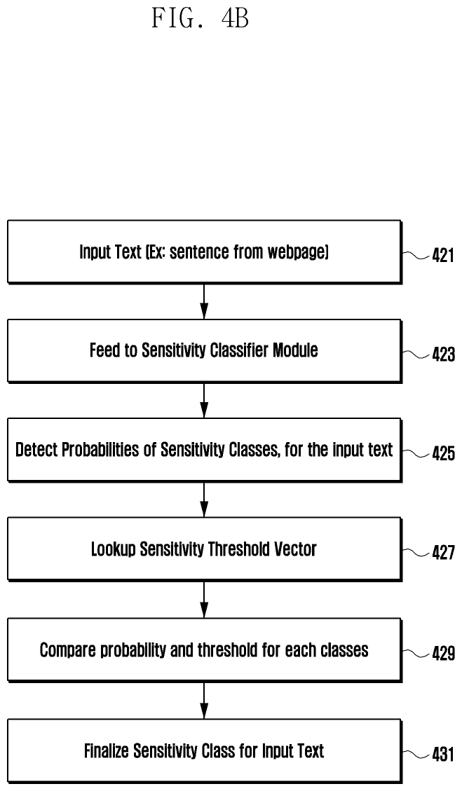

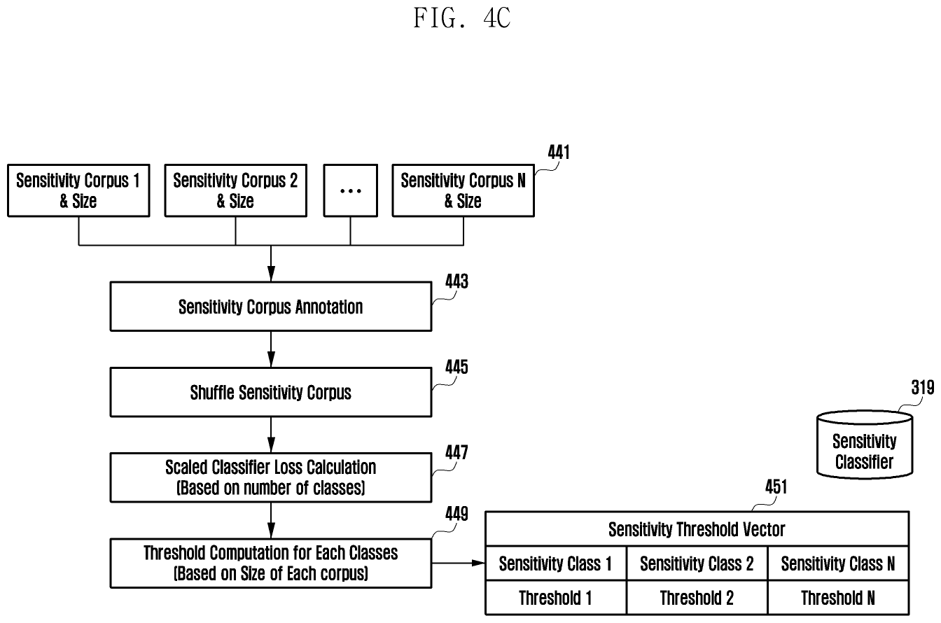

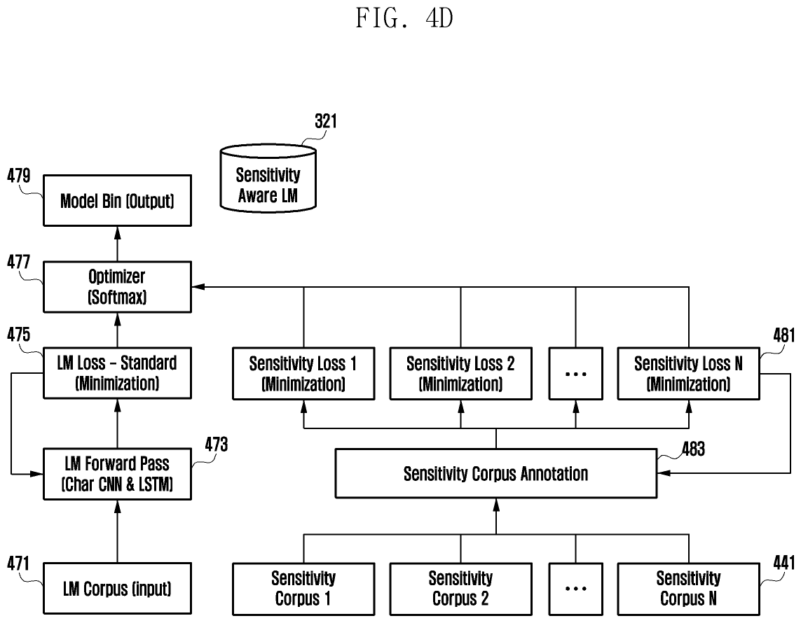

The classification or categorization of insensitive datasets based on bias is explained with reference to FIG. 4A and FIG. 4B.

Referring to FIGS. 4A-4B, when the user is accessing a web browser or social media such as Whatsapp® or mail 401 on the user device 100, the text sensitivity assisting system 300 extracts and inputs the text (or sentences) from the web browser or the social media or the mail 401 in step 421. Subsequently, the extracted text is fed via a sensitivity wrapper module 403 to convert the extracted text to vector format and then passed to the sensitivity classifier module 319 in step 423. The sensitivity classifier module 319 may be referred as a sensitivity engine module 405. The extracted text in the vector format may be passed through a clause extraction module 4051 for extracting clauses (i.e., parsing the extracted text).

Next, the extracted clauses are passed through a sensitive detection module 4053 for detecting probabilities of sensitivity of the extracted clauses against a category of bias (i.e. country bias, political bias, entity bias, hate speech, and gender bias) in step 425. The classifier 409 may output a probability value for the extracted clauses against each of sensitivity classes such as country bias, political bias, entity bias, hate speech and gender bias. In step 427, a sensitivity threshold vector is looked up (i.e., accessed from storage). The probability values are compared with the sensitivity threshold vector, which may include pre-defined threshold values (i.e. threshold scores) for each category of bias, by the sensitive detection module 4053 in step and 429. Based on the comparison, in step 431, the sensitive detection module 4053 finalizes a sensitivity class of the extracted clauses based on the probabilities and thresholds (i.e., the sensitive detection module 4053 may identify if the extracted clauses belong to one or more categories of bias). A model training module 411, a standard loss calculation module 413, a classifier loss calculation module 415 and an optimizer module 419 may be part of the sensitivity aware language model 321. The categories of gender adversary corpus, hate speech adversary corpus, and insensitive adversary corpus 407 may refer to different categories of insensitive datasets within adversarial database 311.

The other data 313 may store data, including temporary data and temporary files, generated by one or more modules 315 for performing the various functions of the text sensitivity assisting system 300.

The data 307 in the memory 305 are processed by the one or more modules 315 present within the memory 305 of the text sensitivity assisting system 300. The one or more modules 315 may be implemented as dedicated hardware units. As used herein, the term module refers to an application specific integrated circuit (ASIC), an electronic circuit, field-programmable gate arrays (FPGA), a combinational logic circuit, and/or other suitable components that provide the described functionality. The one or more modules 315 may be communicatively coupled to the processor 303 for performing one or more functions of the text sensitivity assisting system 300.

The one or more modules 315 may include, but are not limited to, a detecting module 317, a sensitivity classifier module 319, a sensitivity aware language model 321 and a presenting module 323. The one or more modules 315 may include other modules 325 to perform various miscellaneous functions of the text sensitivity assisting system 300. The sensitivity classifier module 319 and the sensitivity aware language model 321 may form an ML model.

The detecting module 317 may detect an input action performed by a user on the user device 100 from a plurality of actions. The plurality of actions may comprise typing one or more words by the user on the virtual keyboard 201 of the user device 100 and accessing the readable content 101 on the user device 100. The readable content 101 may be, but not limited to, online social media, online blogs, online news, user mail and online webpages.

The sensitivity classifier module 319 may perform multiple actions. For instance, when a user is accessing the readable content 101 on the user device 100, the sensitivity classifier module 319 may parse the readable content 101 by extracting sentences from the readable content 101 and subsequently, extracting words from the extracted sentences. These extracted words may be checked for insensitivity with respect to insensitive datasets of the adversarial database 311. The output (i.e., the readable content 101 being insensitive or not to the user) may be sent to the presenting module 323. The sensitivity classifier module 319 may be a deep neural network-based machine learning model trained with insensitive datasets of the adversarial database 311. The sensitivity classifier module 319 may predict the type of insensitiveness in the readable content 101 on the user device 100 based on one of country bias, political bias, entity bias, hate speech and gender bias. When the user is typing one or more words on the virtual keyboard 201 of the user device 100, the sensitivity classifier module 319 may work together with the sensitivity aware language model 321 to parse the one or more words. These parsed words may be checked for insensitivity with respect to insensitive datasets of the adversarial database 311. The output (i.e., the one or more words being insensitive or not to the user) may be sent to the presenting module 323. The sensitivity classifier module 319 may predict the type of insensitiveness in the one or more words based on one of country bias, political bias, entity bias, hate speech and gender bias. The sensitivity classifier module 319 may be trained with insensitive datasets of the adversarial database 311 by collecting text (or sentences) containing a dataset belonging to one or more of various insensitivity types, such as country bias, political bias, entity bias, hate speech, and gender bias. The text (or sentences) may be collected from different online and/or offline sources including, but not limited to, webpages, social media pages and mail. The sensitivity classifier module 319 may be first trained with the collected text (or sentences) to identify insensitivity in the text. Subsequently, the collected text (or sentences) may be shuffled while preserving their identities (i.e., sensitivity type) of the text. This new data may be referred as training data. Using this training data and back-propagation technique, the sensitivity classifier module 319 may be optimized or trained.

The different modules within the sensitivity classifier module 319 for training the sensitivity classifier module 319 are explained with reference to FIG. 4C.

Referring to FIG. 4C, sensitivity corpus 1 and size, sensitivity corpus 2 and size, and sensitivity corpus N and size 441 may individually refer to insensitive datasets, and the sensitivity corpus 1 and size, the sensitivity corpus 2 and size, and the sensitivity corpus N and size 441 together form the adversarial database 311. Each of the sensitivity corpus 1 and size, sensitivity corpus 2 and size, and sensitivity corpus N and size 441 may refer to one insensitive dataset. For instance, the sensitivity corpus 1 and size may refer to a dataset belonging to hate speech bias and the sensitivity corpus 2 and size may refer to a dataset belonging to offensive bias. An additional sensitivity corpus and size may refer to a dataset belonging to political bias. The sensitivity corpus annotation module 443, shuffle sensitivity corpus module 445, scaled classifier loss calculation module 447, threshold computation module 449 and sensitivity threshold vector module 451 may form the sensitivity classifier 319. Text (or sentences) may be extracted from each of the sensitivity corpus 1 and size, the sensitivity corpus 2 and size, and the sensitivity corpus N. For example, “John is a terrible father” may be extracted from the sensitivity corpus 1 and size and “He is a donkey” may be extracted from sensitivity corpus 2 and size. The text (or sentences) extracted from the sensitivity corpus 1 and size, the sensitivity corpus 2 and size may be sent to the sensitivity corpus annotation module 443. The sensitivity corpus annotation module 443 may add annotation to the extracted text (or sentences). For instance, the sensitivity corpus annotation module 443 may assign a “John is a terrible father” and “He is a donkey” annotation (or label) as [0, 1, . . . , 0] and [0, 0, 1, . . . , 0], respectively. Here, each “1” in the annotation may represent the sensitivity class. The annotation may be terms like “Offensive”, “Hate speech”, and “Gender” instead of numerals (i.e., 0 and 1). This annotation along with the extracted text (or sentences) may be sent to the shuffle sensitivity corpus module 445. The shuffle sensitivity corpus module 445 may apply statistical distribution to extracted text (or sentences) based on sentence length and number of sentences. Each portion of text (or sentences) of the sensitivity corpus 1 and size, sensitivity corpus 2 and size, and sensitivity corpus N and size 441 may be merged to form a merged corpus. The merged corpus may be considered for statistical distribution. The application of statistical distribution reduces the perplexity of the sensitivity classifier module 319 and improves key performance indicators (KPIs). The shuffle sensitivity corpus module 445 may next shuffle the merged corpus such that training batch generator may generate heterogeneous sensitive class batches for model training. The application of shuffling allows the sensitivity classifier module 319 to learn different sentence context instead of associating with the same context. For example, Table 1, below, shows output of the sensitivity corpus annotation module 443, and Table 2, below, shows output of the shuffle sensitivity corpus module 445 when the output of the sensitivity corpus annotation module 443 is passed through the shuffle sensitivity corpus module 445.

TABLE 1

| Corpus Size | | |
|---|---|---|
| (Split sentences) | Sample Corpus | Annotation |
| ~50K | <s> John is a terrible father <e> | Offensive |
| | <s> He is incapable of doing | |
| | this task <e> | |
| ~30 L | <s> Sample Data set <e> | Hate_speech |
| ~1 L | <s> Sample Data set <e> | Gender |
| . . . | . . . | . . . |

TABLE 2

| Sample | Annotation (Class) |
|---|---|
| <s> John is a terrible father <e> | Offensive |
| <s> Hindus and Muslims should go to war <e> | Hate speech |
| . . . | . . . |
| <s> He is incapable of doing this task <e> | Offensive |
| <s> He is a donkey <e> | Vulgar |

The output of the shuffle sensitivity corpus module 445 may be sent to the scaled classifier loss calculation module 447 to calculate a fair loss for the sensitivity classifier module 319 to predict a correct sensitive class. The scaled classifier loss calculation module 447 may consider loss for both true (1) and false (0) label classes. Since the true label class may only be one and the false label classes may be many (n−1), the scaled classifier loss calculation module 447 may normalize the loss from the false label classes to scale it with the true label class. This approach allows the sensitivity classifier module 319 to learn a sensitive class label of a sentence effectively. As a result, the sensitivity classifier module 319 may give a high probability for the true class label and a low probability for the false class labels. The loss may be calculated using Formula 1, below. The first term is for calculating loss for False class (0) labels and the second term is for calculating loss for True class (1) label.

$$Loss ( SL ) = \frac{{\sum }_{i \neq 1} \sqrt[2]{\vert {σ ( {out}_{i} )}^{2} - {y}_{i}^{2} \vert}}{n - 1} + \sqrt[2]{\vert {σ ( {out}_{i = 1} )}^{2} - {y}_{i = 1}^{2} \vert} \qquad Formula 1$$

For example, if an actual label is supposed to be [1, 0, 0, 0] and the sensitivity classifier module 319 outputs the label as [0.8, 0.4, 0.2, 0.4], then loss for false class (0) labels may be calculated using Formula 2, below.

$$\sqrt[2]{\vert {σ ( 0.4 )}^{2} - {0}^{2} \vert} + \sqrt[2]{\vert {σ ( 0.2 )}^{2} - {0}^{2} \vert} + … \qquad Formula 2$$

A true class (1) label may be calculated using Formula 3, below.

$$\sqrt[2]{\vert {σ ( 0.8 )}^{2} - {1}^{2} \vert} \qquad Formula 3$$

The sensitivity classifier module 319 may be penalized for predicting a non-zero false class probability. The output of the scaled classifier loss calculation module 447 may be sent to an optimizer module for training the model (i.e., the sensitivity classifier module 319 in this case).

The threshold computation module 449 may compute threshold score for each sensitivity class based on a size of each corpus. The threshold scores may be calculated for individual sensitivity class probability by averaging the sensitivity classifier module 319 output over that sensitivity class samples. The output of the threshold computation module 449 may be sent to the sensitivity threshold vector module 451. The sensitivity threshold vector module 451 may maintain respective threshold scores for sensitivity classes.

The sensitivity aware language model 321 may perform action when a user is typing the one or more words on the user device 100. For instance, when the user is typing one or more words on the virtual keyboard 201 of the user device 100, the sensitivity aware language model 321 may work together with the sensitivity classifier module 319 to parse the one or more words. These parsed words may be checked for insensitivity with respect to insensitive datasets of the adversarial database 311. If the one or more words are determined to be insensitive, the sensitivity aware language model 321 may predict a next word to be suggested to the user to be insensitive. In such a situation, the sensitivity aware language model 321 may provide, to the presenting module 323, one or more alternate words for the next word, instead of the predicted next word, as a suggestion to the user for typing on the user device 100. The one or more alternate words for the suggested next word may not be insensitive words. If the one or more words are determined to be sufficiently sensitive, the sensitivity aware language model 321 may predict a next word normally (instead of the one or more alternate words as next word) and may provide, to the presenting module 323, the predicted next word as a suggestion to the user for typing on the user device 100. The sensitivity aware language model 321 may be a deep neural network-based machine learning model trained with insensitive datasets of the adversarial database 311.

The different modules within the sensitivity aware language model 321 for training the sensitivity aware language model 321 are explained with reference to FIG. 4D.

Referring to FIG. 4D, sensitivity corpus 1, sensitivity corpus 2, and sensitivity corpus N 441 may refer to insensitive datasets and the sensitivity corpus 1, the sensitivity corpus 2, and the sensitivity corpus N 441 together form the adversarial database 311. Each of the sensitivity corpus 1, sensitivity corpus 2, and sensitivity corpus N 441 may refer to one insensitive dataset. For instance, the sensitivity corpus 1 may refer to a dataset belonging to hate speech bias and the sensitivity corpus 2 may refer to a dataset belonging to offensive bias. An additional sensitivity corpus may refer to a dataset belonging to political bias. The model forward pass module 483; the sensitivity loss module 1, sensitivity loss module 2, . . . , sensitivity loss module N 481; the LM (language model) corpus module 471; the LM forward pass module 473; the LM loss−standard module 475; the optimizer module 477 and the model bin module 479 may form the sensitivity aware language model 321. Text (or sentences) may be extracted from each of the sensitivity corpus 1, the sensitivity corpus 2, and the sensitivity corpus N. The extracted text (or sentences) may be sent to the sensitivity corpus annotation module 443. The sensitivity corpus annotation module 443 may add annotation to the extracted text (or sentences). This annotation, along with the extracted text (or sentences), may be sent to the forward pass module 483. The forward pass module 483 may forward the extracted text (or sentences) to the sensitivity loss module 1, sensitivity loss module 2, . . . , sensitivity loss module N 481 to calculate sensitivity loss. The sensitivity loss may be used to normalize the output of sensitivity aware language model 321 probabilities such that the output is comparable with the threshold computation module 449. The sensitivity loss may be calculated using Formula 4, below.

$$Loss ( SL ) = \frac{\begin{matrix}{\sum }_{sensitive \_ class} \sum {y}_{actual \_ word} * \\ log {y}_{s e n s i t i ν {e}_{-} {word}_{-} p r e d i c t i o n}\end{matrix}}{{\sum }_{sens i t i v {e}_{-} c l ass}^{′}} \qquad Formula 4$$

The sensitivity loss is calculated such that the loss on the sensitivity corpus 1, the sensitivity corpus 2, and the sensitivity corpus N is maximized to unlearn the prediction of sensitive next word predictions. The output of the sensitivity loss module 1, sensitivity loss module 2, . . . , sensitivity loss module N 481 may be sent to the optimizer module 477. The LM corpus module 471 may be an input (text or sentences) from a user on the user device 100. The LM forward pass module 473 may send the input to the LM loss−standard module 475. The LM loss−standard module 475 may calculate standard loss to minimize loss for the input to learn a prediction of a next word. The standard loss may be calculated using Formula 5, below.

Loss(LM)=−Σy_{actual}_{_{word}}*log y_{predicted}_{_{word}} Formula 5

The output of the LM loss−standard module 475 may be sent to the optimizer module 477. The optimizer module 477 may optimize the sensitivity loss and standard loss and may send the output to the model bin module 479.

The presenting module 323 may perform multiple functions. For instance, when the readable content 101 is determined to be insensitive by the sensitivity classifier module 319, the presenting module 323 may present a first alert message on the user device 100 before displaying the readable content 101 completely on the user device. When the readable content 101 is determined to be insensitive by the sensitivity classifier module 319, the presenting module 323 may display the readable content 101 completely on the user device 100 only after receiving user consent. When the one or more words are determined to be insensitive by the sensitivity classifier module 319, the presenting module 323 may present a second alert message on the user device 100. When the next word is predicted to be insensitive by the sensitivity aware language model 321, the presenting module 323 may present one or more alternate words for the next word as a suggestion on the words suggestion area 205 for typing on the typed message area 203 on the user device 100.

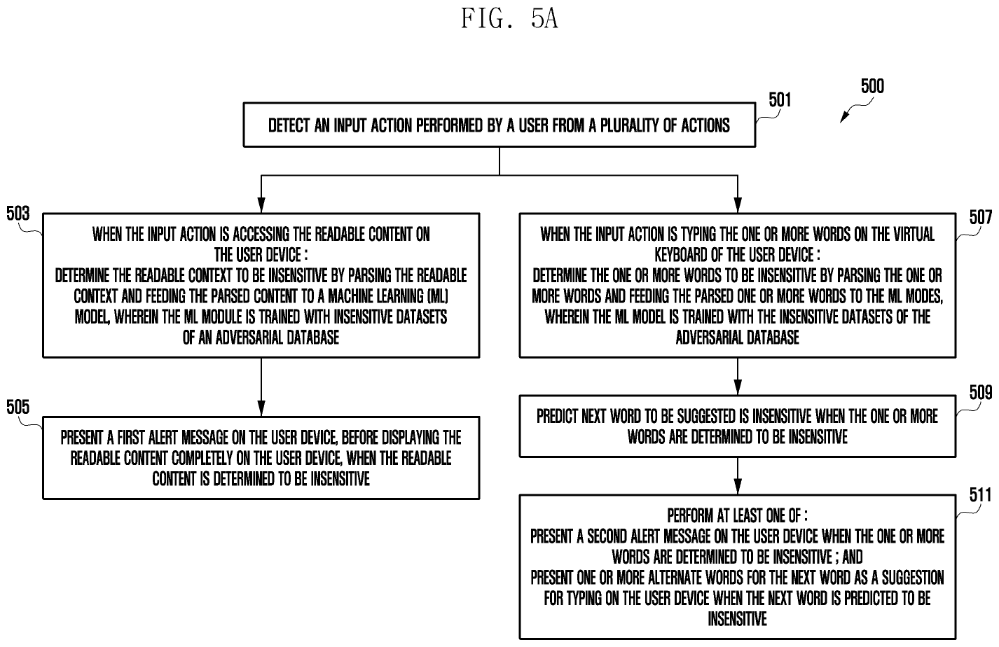

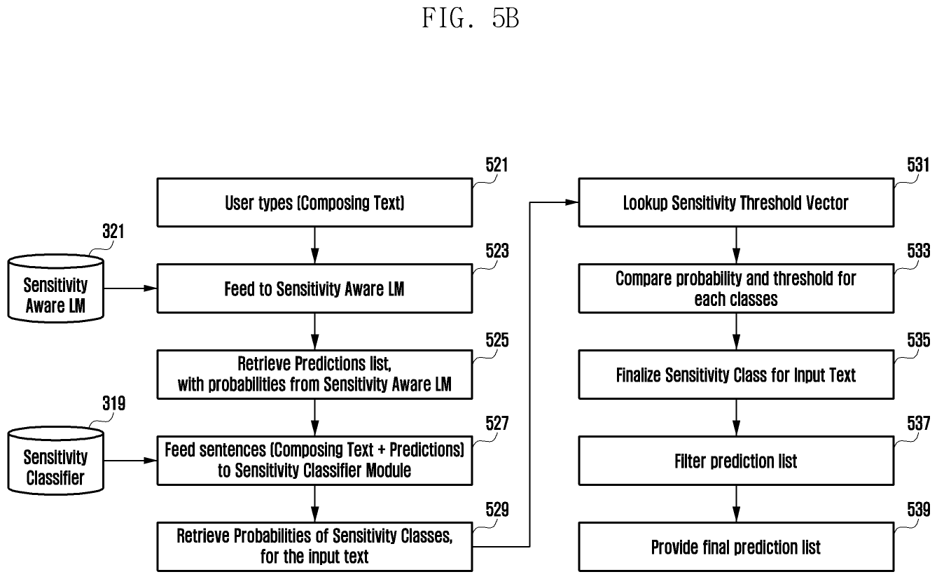

FIG. 5A illustrates a flowchart showing a method for determining sensitivity-based bias of a text in, according to an embodiment.

Referring to FIG. 5A, the method 500 includes one or more blocks for determining sensitivity-based bias of a text. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the method without departing from the scope of the subject matter described. Furthermore, the method can be implemented in any type of suitable hardware, software, firmware, or combination thereof.

At step 501, the text sensitivity assisting system 100 detects an input action performed by a user from a plurality of actions. The plurality of actions may comprise typing one or more words on a virtual keyboard of a user device, receiving, from various applications in the device, a message for the user which has text content, and accessing a readable content on the user device.

At step 503, when the input action is accessing the readable content on the user device, the text sensitivity assisting system 100 determines the readable content to be insensitive by parsing the readable content and feeding the parsed content to an ML model. The ML model is trained with insensitive datasets of an adversarial database.

At step 505, when the readable content is determined to be insensitive, the text sensitivity assisting system 100 presents a first alert message on the user device before displaying the readable content completely on the user device. Furthermore, the text sensitivity assisting system may receive user consent before displaying the readable content completely on the user device, when the readable content is determined to be insensitive.

At step 507, when the input action is typing the one or more words on the virtual keyboard of the user device, the text sensitivity assisting system 100 determines the one or more words to be insensitive by parsing the one or more words and feeding the parsed one or more words to the ML model. The ML model may be trained with the insensitive datasets of the adversarial database.

At step 509, the text sensitivity assisting system 100 predicts that the next word to be suggested is insensitive when the one or more words are determined to be insensitive.

At step 511, the text sensitivity assisting system 100 performs at least one of presenting a second alert message on the user device when the one or more words are determined to be insensitive, and presenting one or more alternate words for the next word as a suggestion for typing on the user device when the next word is predicted to be insensitive. The one or more alternate words for the suggested next word may not be insensitive words.

The first alert message and the second message may contain information on bias. Furthermore, the first alert message and the second alert message may contain information indicating a category of bias.

FIG. 5B illustrates a detailed flowchart showing a method for determining sensitivity-based bias of text, according to an embodiment.

Referring to FIG. 5B, at step 521, the text sensitivity assisting system 100 detects typing one or more words on a virtual keyboard of a user device.

At step 523, the one or more words are fed (i.e., provided) to the sensitivity aware language model 321. At step 525, a sensitivity aware predictions list is retrieved (i.e., output). The prediction list may comprise one or more next words to be suggested. At step 527, the predictions list along with the one or more words are fed to the sensitivity classifier module 319. At step 529, a probabilities of sensitivity classes for the prediction list is retrieved (i.e., output).

At step 531, a sensitivity threshold vector is looked up (i.e., acquired from storage). At step 533, the probabilities of sensitivity classes of the prediction list are compared with threshold scores for sensitivity classes from the sensitivity threshold vector 451. If the probability of a sensitivity class is above threshold score, the one or more next words in the prediction list are finalized as (i.e., considered) sensitive at step 535. The sensitive one or more next words are filtered from the prediction list at step 537. At step 539, the filtered prediction list may be provided (i.e., shown) to a user.

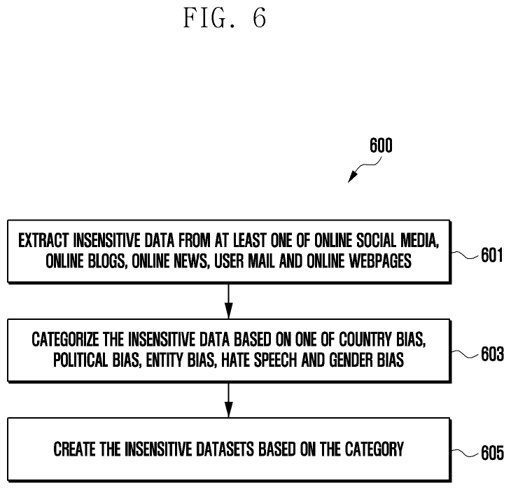

FIG. 6 illustrates a flowchart showing a method for populating an adversarial database in accordance with some embodiments of present disclosure.

Referring to FIG. 6, the method 600 includes one or more blocks for populating an adversarial database. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method. Additionally, individual blocks may be deleted from the method without departing from the scope of the subject matter described herein. Furthermore, the method can be implemented in any type of suitable hardware, software, firmware, or combination thereof.

At step 601, the text sensitivity assisting system 100 extracts insensitive data from at least one of online social media, online blogs, online news, user mail and online webpages.

At step 603, the text sensitivity assisting system 100 categorizes the insensitive data extracted at block 601 based on one of country bias, political bias, entity bias, hate speech and gender bias.

At step 605, the text sensitivity assisting system 100 creates the insensitive datasets based on the category.

Accordingly, the present disclosure advantageously overcomes text sensitivity bias by identifying text sensitivity, categorizing insensitive text into different bias categories such as country bias, political bias, entity bias, hate speech and gender bias, and making users aware of insensitive text and biases in the insensitive text by providing warning and/or suggestions. This allows users to be conscious before continuing with the insensitive text.

Since the text sensitivity assisting system of the present disclosure is an on-device feature (i.e., built in a user device), text (or words) typed by a user on his/her user device is not sent to any external server for checking text insensitivity or for suggesting non-sensitive text. Rather, the checking text insensitivity may be resolved locally by the text sensitivity assisting system. This approach protects privacy of the user using the user device with the text sensitivity assisting system.

The text sensitivity assisting system of the present disclosure uses a machine learning (i.e. deep learning) technique for updating the adversarial database, which allows the adversarial database to be continuously expanded with new and/or upcoming insensitive datasets, thereby, keeping the adversarial database up-to-date with current insensitive trends in social media.

The text sensitivity assisting system of the present disclosure works well on sentences as well as on word to determine text insensitive.

Since the text sensitivity assisting system of the present disclosure is an on-device feature (i.e. in-built in a user device), sensitivity resolution of the text sensitivity assisting system is fast due to low latency and being independent of a network. For example, using the text sensitivity assisting system of the present disclosure, sensitivity resolution takes less than 30 milliseconds for a sentence with an average of 10 words.

With respect to the use of substantially any plural and/or singular terms used herein, those having ordinary skill in the art can translate from the plural to the singular and/or from the singular to the plural as is appropriate in the context and/or application. The singular and plural forms of terms may be interchangeably used.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor may be at least one of a microprocessor and a processor capable of processing and executing the queries. A non-transitory computer readable medium may include media such as magnetic storage medium (e.g., hard disk drives, floppy disks, and tapes), optical storage (compact disc (CD)-read only memories (ROMs), digital versatile discs (DVDs), and optical disks), and volatile and non-volatile memory devices (e.g., electrically erasable programmable read only memories (EEPROMs), ROMs, programmable read only memories (PROMs), random access memories (RAMs), dynamic random access memories (DRAMs), static random access memories (SRAMs), flash memory, firmware, and programmable logic). Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 5A, 5B and 6 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The language used in the specification has been principally selected for readability and instructional purposes, and does delineate or circumscribe the inventive subject matter. It is therefore intended that the scope of the disclosure be limited not by this detailed description, but rather by any claims that issue on an application based here on. Accordingly, the disclosure of the embodiments is intended to be illustrative, but not limiting, of the scope of the disclosure, which is set forth in the claims.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method for determining sensitivity-based bias of text, the method comprising:
detecting an input action performed by a user from a plurality of actions, wherein the plurality of actions includes typing one or more words on a virtual keyboard of a user device and accessing readable content on the user device;
when the input action is accessing the readable content on the user device:
determining the readable content to be insensitive by parsing the readable content and feeding the parsed readable content to a machine learning (ML) model, wherein the ML model is trained with insensitive datasets of an adversarial database; and
presenting a first alert message on the user device before displaying the readable content completely on the user device when the readable content is determined to be insensitive;
when the input action is typing the one or more words on the virtual keyboard of the user device:
determining the one or more words to be insensitive by parsing the one or more words and feeding the parsed one or more words to the ML model;
predicting that a next word to be suggested is insensitive when the one or more words are determined to be insensitive; and
performing at least one of:
presenting a second alert message on the user device when the one or more words are determined to be insensitive; and
presenting one or more alternate words for the next word as a suggestion for typing on the user device when the next word is predicted to be insensitive.

2. The method as claimed in claim 1, wherein presenting the first alert message further comprises:
receiving user consent before displaying the readable content completely on the user device when the readable content is determined to be insensitive.

3. The method as claimed in claim 1, wherein the first alert message and the second message contain information on bias.

4. The method as claimed in claim 1, wherein the first alert message and the second alert message contain information indicating a category of bias.

5. The method as claimed in claim 1, wherein the one or more alternate words for the next word as the suggestion are not insensitive words.

6. The method as claimed in claim 1, wherein the adversarial database is populated by:
extracting insensitive data from at least one of online social media, online blogs, online news, user mail and online webpages;
categorizing the insensitive data based on one of country bias, political bias, entity bias, hate speech and gender bias; and
creating the insensitive datasets based on the categorized insensitive data.

7. A server device for determining sensitivity-based bias of text, the server device comprising:
a processor; and
a memory communicatively coupled to the processor, wherein the memory stores processor-executable instructions, which upon execution, cause the processor to:
receive an input action performed by a user from a plurality of actions, wherein the plurality of actions comprises typing one or more words on a virtual keyboard of a user device and accessing readable content on the user device;
when the input action is accessing the readable content on the user device:
determine the readable content to be insensitive by parsing the readable content and feeding the parsed readable content to a machine learning (ML) model, wherein the ML model is trained with insensitive datasets of an adversarial database; and
send a first alert message to the user device before displaying the readable content completely on the user device when the readable content is determined to be insensitive;
when the input action is typing the one or more words on the virtual keyboard of the user device:
determine the one or more words to be insensitive by parsing the one or more words and feeding the parsed one or more words to the ML model;
predict that a next word to be suggested is insensitive when the one or more words are determined to be insensitive; and
perform at least one of:
sending a second alert message to the user device when the one or more words are determined to be insensitive; and
sending one or more alternate words for the next word as a suggestion for typing on the user device when the next word is predicted to be insensitive.

8. The server device as claimed in claim 7, wherein the memory stores processor-executable instructions, which upon execution, further cause the processor to:
receive user consent before displaying the readable content completely on the user device when the readable content is determined to be insensitive.

9. The server device as claimed in claim 7, wherein the first alert message and the second message contain information on bias.

10. The server device as claimed in claim 7, wherein the first alert message and the second alert message contain information indicating a category of bias.

11. The server device as claimed in claim 7, wherein the one or more alternate words for the next word as the suggestion are not insensitive words.

12. The server device as claimed in claim 7, wherein the processor is further configured to populate the adversarial database by:
extracting insensitive data from at least one of online social media, online blogs, online news, user mail and online webpages;
categorizing the insensitive data based on one of country bias, political bias, entity bias, hate speech and gender bias; and
creating the insensitive datasets based on the categorized insensitive data.

13. A user device comprising:
a display;
a processor; and
a memory communicatively coupled to the processor, wherein the memory stores processor-executable instructions, which upon execution, cause the processor to:
detect, on the display, an input action performed by a user from a plurality of actions, wherein the plurality of actions comprises typing one or more words on a virtual keyboard of a user device and accessing readable content on the display;
when the input action is accessing the readable content on the display:
determine the readable content to be insensitive by parsing the readable content and feeding the parsed content to a machine learning (ML) model, wherein the ML model is trained with insensitive datasets of an adversarial database; and
present a first alert message on the display before displaying the readable content completely on the display when the readable content is determined to be insensitive;
when the input action is typing the one or more words on the virtual keyboard of the user device:
determine the one or more words to be insensitive by parsing the one or more words and feeding the parsed one or more words to the ML model;
predict that a next word to be suggested is insensitive when the one or more words are determined to be insensitive; and
perform at least one of:
presenting a second alert message on the display when the one or more words are determined to be insensitive; and
presenting one or more alternate words for the next word as a suggestion for typing on the display when the next word is predicted to be insensitive.

14. The user device as claimed in claim 13, wherein the memory stores processor-executable instructions, which upon execution, further causes the processor to:
receive user consent before displaying the readable content completely on the user device when the readable content is determined to be insensitive.

15. The user device as claimed in claim 13, wherein the first alert message and the second message contain information on bias.

16. The user device as claimed in claim 13, wherein the first alert message and the second alert message contain information indicating a category of bias.

17. The user device as claimed in claim 13, wherein the one or more alternate words for the next word as the suggestion are not insensitive words.

18. The user device as claimed in claim 13, wherein the processor is further configured to populate the adversarial database by:
extracting insensitive data from at least one of online social media, online blogs, online news, user mail and online webpages;
categorizing the insensitive data based on one of country bias, political bias, entity bias, hate speech and gender bias; and
creating the insensitive datasets based on the categorized insensitive data.
